(19) United States
(12) Patent Application Publication
(10) Pub. No.: US 2008/0083733 A1
(43) Pub. Date: Apr. 10, 2008

(54) RADIANT HEATER

(76) Inventors: Toshihiro Takai, Aichi-gun (JP); Yasuyoshi Ohashi, Aichi-gun (JP); Kazushi Hayashi, Aichi-gun (JP)

Correspondence Address: WOOD, HERRON & EVANS, LLP, 2700 CAREW TOWER, 441 VINE STREET, CINCINNATI, OH, 45202, US

(21) Appl. No.: 11/558,508

(22) Filed: Nov. 10, 2006

(30) Foreign Application Priority Data
Aug. 29, 2006 (JP) P2006-232254

(51) Int. Cl. H05B 3/68

(52) U.S. Cl. 219/448.17

(57) ABSTRACT

A radiant heater includes a support plate substantially having a rectangular shape, a pair of connection terminals substantially perpendicularly extending, while having; a space therebetween, from one surface of the support plate, a strip-shaped heater element arranged between the pair of connection terminals and covering the one surface of the support plate) a width direction of the strip-shaped heater element being in parallel with the support plate, and bridging support members provided with insulators and extending) while having a space therebetween, from the support plate for supporting the strip-shaped heater element separately from the support plate, wherein a heating surface of the strip-shaped heater element that is to face a heated object is provided with a coating that increases a radiation factor, and an opposing surface that is on an opposite side of the heating surface and faces the support plate is not provided with the coating

### BACKGROUND OF THE INVENTION

1. Field of the Invention

The present invention relates to a radiant heater in which the temperature of a heating element is increased so as to heat a heated object using radiant heat from the heating element, and in particular, relates to a radiant heater that is suitable for a heating unit of a shaping apparatus that is used for shaping a thermoplastic resin sheet.

Priority is claimed on Japanese Patent Application No. 2006-232254, filed Aug. 29, 2006, the content of which is incorporated herein by reference.

2. Description of Related Art

Conventionally, as the type of radiant heater described above, a radiant heater has been proposed, as disclosed, for example, in Japanese Unexamined Patent Application, First Publication No. 2002-260831T in which a strip-shaped heater element is arranged on one surface of a support plate in which a pair of connection terminals are arranged while having a space therebetween in such a manner that the width direction of the strip-shaped heater element is in parallel with the support plate, and the strip-shaped heater element substantially covers an entirety of the one surface of the support plate.

In this radiant heater, the strip-shaped heater element is directly heated by supplying electrical power to the strip-shaped heater element via the connection terminals, and a heated object is heated using radiant heat from the strip-shaped heater element.

In such a radiant heater, the temperature of the strip-shaped heater element can be adjusted by changing electrical current or voltage being supplied to the strip-shaped heater element, and the state of heating of the heated object due to the radiant heater can be controlled in a preferable responsive manner.

Accordingly, when such a radiant heater is used for the heating unit of the aforementioned shaping apparatus, the state of heating of the radiant heater can be instantaneously adjusted by feeding back the measured temperature of the thermoplastic resin sheet, which is a heated object, and it is possible to heat the thermoplastic resin sheet to a predetermined temperature.

Incidentally, when the strip-shaped heater element is heated by being supplied with electrical power, heat is radiated not only from the surface of the strip-shaped heater element that faces the heated object (heating surface), but also from the surface of the strip-shaped heater element that faces the support plate (opposing surface). Due to this, problems are encountered in that the support plate thermally deforms because the temperature of the support plate rises due to radiant heat, or in that the service life of the connection terminals or of power source lines connected to the connection terminals is shortened.

Moreover, there has been provided another type of radiant heater in which radiant heat radiated from the opposing surface of the strip-shaped heater element is reflected toward the heated object by providing a reflection plate having a high reflectance on the support plate; however, in such a case, the state of heating of the heated object by the radiant heater is determined by the radiant heat from the heating surface of the strip-shaped heater element and the reflected heat from the reflection plate. If the reflectance of the reflection plate is decreased due to oxidization of or contaminants on the surface of the reflection plate, the reflected heat is decreased, and thus the state of heating by the radiant heater varies depending on the surface condition of the reflection plate.

Accordingly, if a plurality of radiant heaters are used while being arranged side by side, the states of heating of the radiant heaters become uneven, and the heated object may not be evenly heated.

### SUMMARY OF THE INVENTION

The present invention was made in view of the aforementioned circumstances, and an object thereof is to provide a radiant heater which makes it possible to efficiently heat a heated object by increasing radiation of heat from a heating surface of a strip-shaped heater element that faces the heated object, and to elongate service lives of a support plate and connection terminals by restraining radiation of heat from an opposing surface that faces the support plate thereby restraining temperature rise in the support plate and the connection terminals.

In order to achieve the above object, the present invention provides a radiant heater including: a support plate substantially having a rectangular shape; a pair of connection terminals substantially perpendicularly extending, while having a space therebetween, from one surface of the support plate; a strip-shaped heater element arranged between the pair of connection terminals and covering the one surface of the support plate, a width direction of the strip-shaped heater element being in parallel with the support plate; and bridging support members provided with insulators and extending, while having a space therebetween, from the support plate for supporting the strip-shaped heater element separately from the support plate, wherein a heating surface of the strip-shaped heater element that is to face a heated object is provided with a coating that increases a radiation factor, and an opposing surface that is on an opposite side of the heating surface and faces the support plate is not provided with the coating.

According to the radiant heater configured above, because the coating that increases the radiation factor is formed on the heating surface of the strip-shaped heater element that faces the heated object, radiation of heat from the heating surface is increased, and the heated object can be efficiently heated. Moreover, because the coating that increases the radiation factor is not formed on the opposing surface of the strip-shaped heater element that faces the support plate, radiation of heat from the opposing surface is restrained. Therefore, temperature rise in the support plate is restrained, thermal effects to the support plate and the connection terminals can be restrained, and the service lives of these elements can be elongated.

Furthermore, because radiant heat from the opposing surface is restrained, it is not necessary to provide a reflection plate having a high reflectance on the support plate to reflect heat, and the state of heating by the radiant heater does not vary depending on the surface condition of the reflection plate. More specifically, in this radiant heater, the reflected heat hardly contributes to heating, and only radiant heat from the heating surface of the strip-shaped heater element contributes to heating of the heated object. Therefore, variation of the state of heating in the radiant heaters is small, and the state of heating in each of the radiant heaters is maintained constant even if the radiant heaters are used while being arranged side by side, and thus the heated object can be evenly heated.

By configuring the strip-shaped heater element so as to have a V-shaped cross section such that a portion of the heating surface of the strip-shaped heater element that is located at middle in the width direction thereof is projected, the rigidity of the strip-shaped heater element can be increased because the V-shaped ridge line functions as a rib, and thus deformation of the strip-shaped heater element in such a manner that a portion thereof located between the bridging support members is sagged can be prevented.

Furthermore, by providing a heat insulator between the support plate and the opposing surface of the strip-shaped heater element, conduction of heat to the support plate can be further restrained, temperature rise in the support plate and the connection terminals can be restrained, and thereby service lives of the support plate and the connection terminals can be elongated.

Moreover, it is preferable that the strip-shaped heater element be configured such that an area of the heating surface occupies 55% to 75% of an area of the support plate when viewed from a position facing the heating surface.

By making the area of the heating surface occupy 55% or more of the area of the support plate, the heated object can be evenly heated even only by radiant heat from the strip-shaped heater element itself.

Moreover, by making the area of the heating surface occupy 75% or less of the area of the support plate, space between the portions of the strip-shaped heater element that are disposed side by side can be ensured. Therefore, even when the strip-shaped heater element deforms due to thermal expansion thereof, mutual contact of the portions of the strip-shaped heater element that are disposed side by side can be prevented, and a heating operation can be stably carried out even the temperature of the strip-shaped heater element is increased so that the radiant heat therefrom is increased.

In order to enhance these effects, it is more preferable that the strip-shaped heater element be configured such that the area of the heating surface occupies 60% to 70% of the area of the support plate.

As described above, according to the present invention, a radiant heater is provided which makes it possible to efficiently heat a heated object by increasing radiation of heat from a heating surface of a strip-shaped heater element that faces the heated object, and to elongate service lives of a support plate and connection terminals by restraining radiation of heat from an opposing surface that faces the support plate thereby restraining temperature rise in the support plate and the connection terminals.

### BRIEF DESCRIPTION OF THE DRAWINGS

FIG. 1 is a plan view of a radiant heater as an embodiment.

FIG. 2 is a cross-sectional view of the radiant heater shown in FIG. 1.

FIG. 3 is a partially enlarged cross-sectional view of a strip-shaped heater element included in the radiant heater shown in FIG. 1.

### DETAILED DESCRIPTION OF THE INVENTION

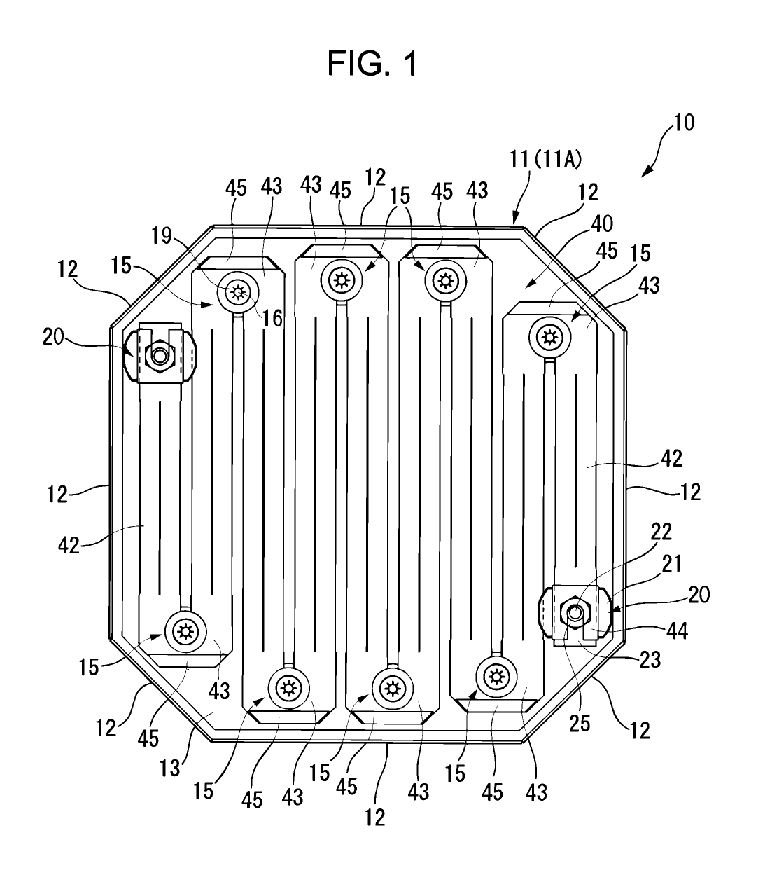

An embodiment of the present invention will be explained below with reference to the drawings. FIGS. 1 to 3 show a radiant heater as an embodiment.

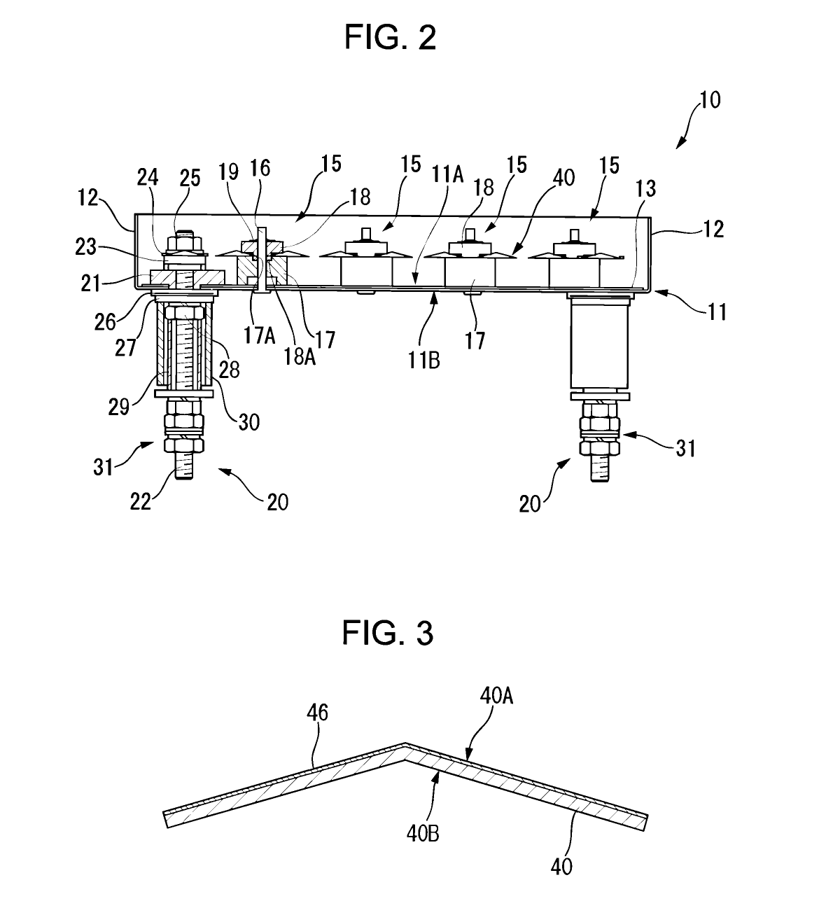

The radiant heater 10 includes a support plate 11 having a substantially square plate shape, and a strip-shaped heater element 40 disposed above a surface 11A (shown as an upper surface in FIG. 2) of the support plate 11 that is oriented in one direction.

The support plate 11 is made of, for example, a stainless steel plate, and more specifically, has an outline of an octagonal plate shape that is conceptually made by cutting, off four corners of a square plate along lines each of which intersects the sides of the square plate at 45°. At each side of the octagonal plate, a side wall portion 12 is provided which is made by bending in the direction in which the surface 11A is oriented so as to be perpendicular to the support plate 11. As a result, the support plate 11, as a whole, has an octagonal tray shape. A slit is defined between the pair of side wall portions 12 that are provided at the sides of the octagonal plate.

A mica sheet 13 as a heat insulator is adhered to the surface 11A of the support plate 11 that is oriented in the one direction. The mica sheet 13 has superior heat insulation property and electrical insulation property.

Furthermore, bridging support members 15 and a pair of connection terminals 20 are provided on the surface 11A of the support plate 11 that is oriented in the one direction. In this embodiment, as shown in FIG. 1, the pair of connection terminals 20 is disposed on the diagonal of the octagonal plate (at upper-left and lower-right in FIG. 1), and eight bridging support members 15 are alternately disposed between the pair of connection terminals 20 and along a pair of opposed sides (the sides located at the upper and lower portions in FIG. 1) of the octagonal plate. The height of the bridging support members 15 and the pair of connection terminals 20 from the surface 11A of the support plate 11 that is oriented in the one direction is set lower by one step than that of the side wall portions 12.

As shown in FIG. 2, the bridging support member 15 includes a stud pin 16 that is fixed such that the stud pin 16 penetrates through a through hole formed in the support plate 11 and projects from the surface 11A oriented in the one direction a pair of spacers (a first spacer 17 and a second spacer 18) having a substantially cylindrical shape through which the stud pin 16 penetrates, and a bush nut 19 for fixing the pair of spacers.

The first spacer 17 that is disposed on the surface 11A of the support plate 11 that is oriented in the one direction via the mica sheet 13 is made of an electrical insulator, and a recess 17A is formed at the center of one surface of the first spacer 17.

The second spacer 18 is also made of an electrical insulator, and has a projected portion 18A that projects toward the other side (downward in FIG, 2) and that is engageable with the recess 17A. The projected height of the projected portion 18A is made greater than the depth of the recess 17A, and thus a small space is formed around a portion of the stud pin 16 located between the first and second spacers 17 and 18.

Each connection terminal 20 includes an insulation piece 21 that has a rectangular plate shape and is pressed into a through hole formed at a corner portion of the support plate from the surface 11A oriented in the one direction, and a bolt 22 that penetrates through the support plate 11 and the insulation piece 21 and projects from the surface 11A of the support plate 11 that is oriented in the one direction and from the surface 11B of the support plate 11 that is oriented in the other direction.

An electrode metal member 23, a washer 24, and a fixing nut 25 are provided, in this order away from the insulation piece 21, at a portion of the bolt 22 that projects from the surface 11A of the support plate 11 that is oriented in the one direction. Moreover, an insulation washer 26 is disposed at a portion of the bolt 22 that projects from the surface 11B of the support plate 11 that is oriented in the other direction and is fixed by a washer 27 and a nut 28 while contacting the surface 11B that is the other surface of the support plate 11. Furthermore, an internal tube 29 is disposed at a position away from the washer 27, an insulation tube 30 is disposed outside the internal tube 29, and a connection portion 31 to which a power supply cable (not shown) is to be connected is constituted by nuts and washers at a position away from the internal tube 29 and insulation tube 30.

The strip-shaped heater element 40 is formed by cutting off a nichrome plate having a thin plate shape from the right and left alternately so as to form elongated nicks therein so that the strip-shaped heater element 40 configured to have a zigzag shape in which strip-shaped portions 42 and turning portions 43 are alternately disposed.

Each end of the strip-shaped heater element 40 is cut off in U-shape, and a reinforcing member 44 having a similar U-shape is stacked and connected to the end. The ends of the strip-shaped heater element 40 are disposed at opposing corners thereof.

Moreover, a recess (not shown) with which the projected portion 18A of the second spacer 18 constituting the bridging support member 15 is engageable is formed at an inside portion of the turning portion 43. Furthermore, a conductive member 45 having a small thin plate configuration is stacked and adhered to an outside portion of the turning portion 43.

Moreover, as shown in FIG. 3, the cross section of the strip-shaped heater element 40 (the cross section perpendicular to the direction in which the strip-shaped heater element 40 extends) is bent in a V-shape in such a manner that the center of the width thereof is projected in the one direction (shown as upward direction in FIG. 3). A coated film 46 is formed on the surface of the strip-shaped heater element 40 that is oriented in the one direction by painting a synthetic resin paint having a heat resistance and exhibiting black color to increase a radiation factor, and the coated film 46 is not formed on the surface of the strip-shaped heater element 40 that is oriented in the other direction. In other words, the coated film 46 is selectively formed only on the surface of the strip-shaped heater element 40 that is oriented in the one direction,

Here, the surface of the strip-shaped heater element 40 that is oriented in the one direction on which the coated film 46 is formed is used as a heating surface 40A that is disposed so as to face a heated object, and the surface that is oriented in the other direction on which the coated film 46 is not formed is used as an opposing surface 40B.

Moreover, the radiation factor of the heating surface 40A on which the coated film 46 is formed is set to be 0.96, and the radiation factor of the opposing surface 40B on which the coated film 46 is not formed is set in a range of 0.64 to 0.76.

The strip-shaped heater element 40 is mounted on the support plate 11 in the following manner. The ends of the strip-shaped heater element 40 that are cut off in a U-shape and the reinforcing members 44 are placed on the electrode metal members 23 in such a manner that the opposing surface 40B faces the surface 11A of the support plate 11 that is oriented in the one direction, and are fixed by the fixing nuts 25. The fixing nuts 25 are welded to the bolts 22 to prevent loosening.

The recesses formed at the inside portions of the turning portions 43 of the strip-shaped heater element 40 are engaged with the projected portion 18A of the second spacer of the bridging support member 15, and the turning portions 40B are movably supported in the space between the first spacer 17 and the second spacer 18. The tips of the stud pins 16 are deformed to prevent coming-off of the bush nuts 19 that fix the first and second spacers 17 and 18.

As a result, the strip-shaped heater-clement 40 is disposed at a position shifted in the other direction from the ends of the side wall portions 12 while being separated from the surface 11A of the support plate 11 that is oriented in the one direction.

Here, as viewed from a position facing the surface 11A of the support plate 11 that is oriented in the one direction, i.e., from a position facing the heating surface 40A of the strip-shaped heater element 40, the area of the strip-shaped heater element 40 occupies 55% to 75% of the area of the support plate 11, and more specifically, occupies 65% of the area of the support plate 11.

The radiant heater 10 configured as described above carries out heating of the heated object that is disposed so as to face the heating surface 40A in such a manner that a power supply cable is connected to the connection portions 31 of the connection terminals 20, the temperature of the strip-shaped heater element 40 is raised by supplying electrical power to the strip-shaped heater element 40, and radiant heat is radiated from the strip-shaped heater element 40.

In the radiant heater 10 of the present embodiment, because the coated film 46 that increases a radiation factor is formed on the hating surface 40A of the strip-shaped heater element 40 that is disposed so as to face the heated object, radiation of heat from the hating surface 40A is increased, and the heated object can be efficiently heated. In addition, because the coated film 46 is not formed on the opposing surface 40B of the strip-shaped heater element 40 that is disposed so as to face the surface 11A of the support plate 11 that is oriented in the one direction, radiation of heat from the opposing surface 40B is restrained, temperature rise in the support plate 11 is restrained, thermal effects to the support plate 11 and the connection terminals 20 can be restrained, and the service lives of these elements can be elongated.

Furthermore, because radiant heat from the opposing surface 40B is restrained, it is not necessary to provide a reflection plate having a high reflectance on the support plate 11 to reflect heat, and the state of heating by the radiant heater 10 does not vary depending on the surface condition of the reflection plate. More specifically, in this radiant heater 10, the reflected heat hardly contributes to heating, and only radiant heat from the heating surface 40A of the strip-shaped heater element 40 contributes to heating of the heated object. Therefore, variation of the state of heating in the radiant heaters 10 is small even if the radiant heaters 10 are used while being arranged side by side, and thus the heated object can be evenly heated.

Furthermore, because the mica sheet 13 as a heat insulator is adhered to the surface of the support plate 11 that is oriented in the one direction, temperature rise in the support plate 11 and the connection terminals 20 can be further reliably restrained. In the present embodiment, because the mica sheet 13 having superior heat insulation property and electrical insulation property is adhered, leak of electricity to the support plate 11 can be prevented even if the strip-shaped heater element 40 falls on the mica sheet 13.

Moreover, because the area of the heating surface 40A of the strip-shaped heater element 40 occupies 55% to 75% of the area of the support plate 11, and more specifically, occupies 65% of the area of the support plate 11 when viewed from a position facing the heating surface 40A, the heated object can be evenly heated only by radiant heat from the strip-shaped heater element 40, space between the strip-shaped portions 42 that are disposed side by side can be ensured, and thus, even when the strip-shaped heater element 40 deforms due to thermal expansion thereof, mutual contact of the strip-shaped portions 42 can be prevented, and the heated object can be efficiently heated by increasing the temperature of the strip-shaped heater element 40.

Furthermore, in the present embodiment, because the pair of connection terminals 20 is disposed on the diagonal of the support plate 11, the connection terminals 20 are sufficiently separated from each other, and the connecting operation of a power supply cable to the connection terminals 20 can be easily carried out.

Moreover, because a slit is defined between the pair of side wall portions 12 that are provided at the sides of the octagonal surface of the support plate 11, interference between the side wall portions 12 can be prevented when the support plate 11 expands due to heat.

Moreover, because the cross section of the strip-shaped heater element 40 is bent in a V-shape in such a manner that the center of the width thereof is projected in the one direction, the strength of the strip-shaped heater element 40 is increased, and deformation of the strip-shaped heater element 40 during heating in such a manner that a portion thereof is sagged can be prevented.

Moreover, because the conductive member 45 is adhered to an outside portion of the turning portion 43 of the strip-shaped heater element 40, an electrical current path at the turning portion 43 is corrected, and an even current can be achieved.

While a radiant heater as an embodiment of the present invention has been described above, it should be understood that the present invention is not to be considered as limiting, and various modifications can be made without departing from the technical spirit of the invention.

In the present embodiment, the description was made assuming that the strip-shaped heater element is configured in a zigzag shape; however, the configuration is not limited to this, and the strip-shaped heater element may be configured in a spiral shape. It should be noted, however, that a zigzag-shaped configuration of the strip-shaped heater element as in the present embodiment is preferred because the connection terminals can be sufficiently separated from each other, which lead to an easy connecting operation.

The paint is not limited to that in the present embodiment, and any paint that increases the radiation factor of the heating surface may be used. For example, if a nichrome plate is used as the strip-shaped heater element, a paint having color darker than that of the surface of the nichrome plate can increase a radiation factor.

Moreover, the description was made assuming that the support plate has a substantially square shape; however, the configuration is not limited to this, and the support plate may be formed in an arbitrary shape. It should be noted, however, that a substantially square shape configuration is preferred because it is easy to form a heating unit in an arbitrary shape when the heating unit is constituted by arranging a number of radiant heaters side by side.

Moreover, the description was made assuming that the area of the heating surface of the strip-shaped heater element occupies 55% to 75% of the area of the support plate, and more specifically, occupies 65% of the area of the support plate when viewed from a position facing the heating surface; however, the numerical range is not limited to this. It should be noted, however, that this numerical range is preferred in order to reliably attain the effects as that of the radiant heater of the present embodiment.

Furthermore, the description was made assuming that a mica sheet as a heat insulator is adhered; however, the material of the heat insulator is not limited, and any appropriate material can be used.

Moreover, the configuration of the bridging support members and connection terminals is not limited to that in the present embodiment, and any configuration by which the strip-shaped heater element can be reliably supported may be employed.

What is claimed is:

1. A radiant heater comprising:
a support plate substantially having a rectangular shape;
a pair of connection terminals substantially perpendicularly extending, while having a space therebetween, from one surface of the support plate;
a strip-shaped heater element arranged between the pair of connection terminals and covering the one surface of the support plate, a width direction of the strip-shaped heater element being in parallel with the support plate; and
bridging support members provided with insulators and extending, while having a space therebetween, from the support plate for supporting the strip-shaped heater element separately from the support plate, wherein
a heating surface of the strip-shaped heater element that is to face a heated object is provided with a coating that increases a radiation factor, and an opposing surface that is on an opposite side of the heating surface and faces the support plate is not provided with the coating.

2. The radiant heater according to claim 1, wherein the strip-shaped heater element has a V-shaped cross section such that a portion of the heating surface of the strip-shaped heater element that is located at middle in the width direction thereof is projected.

3. The radiant heater according to claim 1, further comprising a heat insulator disposed between the support plate and the opposing surface of the strip-shaped heater element.

4. The radiant heater according to claim 1, wherein the strip-shaped heater element is configured such that an area of the heating surface occupies 55% to 75% of an area of the support plate when viewed from a position facing the heating surface.
